(19) United States
(12) Patent Application Publication
(10) Pub. No.: US 2019/0318292 A1
(43) Pub. Date: Oct. 17, 2019

(54) Method for Assembling a Team of Humans and Robots

(71) Applicant: Siemens Aktiengesellschaft, Muenchen (DE)

(72) Inventor: Daniel Schall, Wien (AT)

(21) Appl. No.: 16/380,470

(22) Filed: Apr. 10, 2019

(30) Foreign Application Priority Data
Apr. 11, 2018 (DE) 102018205418.5

(51) Int. Cl. G06Q 10/06; G06N 3/12; G06N 20/00

(52) U.S. Cl. CPC G06Q 10/063112; G06Q 10/063118; G06N 20/00; G06N 3/126; G06Q 10/06395

(57) ABSTRACT

A method for assembling a team with the aid of a computer, wherein the team is assembled for the purpose of performing a specific task and wherein the team includes humans and robots as members, where the method includes specifying the technical skills that are required to perform the task, picking a subgroup of potential members having these technical skills from a given group of humans and robots, and assembling the members for the team from this subgroup via a genetic algorithm using a fitness function.

### BACKGROUND OF THE INVENTION

### 1. Field of the Invention

The present invention relates to a method for assembling a team with the aid of a computer, where the team is assembled for the purpose of carrying out a specific task and where the team includes humans and robots as members.

The invention also relates to the planning of the cooperation (collaboration) between humans and robots in a shared work area, in particular a shared spatial work area. A shared spatial work area is produced by an overlap of the human work area with the work area of the robot or robots. The collaboration or cooperation results in an interaction between humans and robots. An interaction may be the handover of a workpiece, for example, or humans and robots working simultaneously on a workpiece.

A robot in this context is understood to be a machine that relieves the human of mechanical work and is controlled by computer programs. Robots can be either positionally fixed or mobile machines. A robot for industrial use is generally understood to be a programmable multipurpose handling device for the movement of material, workpieces, tools or special devices. The freely programmable sequence of motions allows the robot to be used for the widest variety of tasks. Robots usually have corresponding sensors for the purpose of recognizing the environment, and learning abilities via which skills can be continuously learned and adapted.

### 2. Description of the Related Art

With successive advances in the field of robotics, in the future both manual and cognitive work will increasingly be taken over by machines in many workplaces. Humans and machines will cooperate side-by-side in this case, and the robots will generally no longer act separately from humans in a specific spatial area only, but will also work at one location, e.g., on the same workpiece, simultaneously or in sequence.

This cooperation will occur primarily in cyber-physical production systems (CPPS). Cyber-physical production systems are the subset of cyber-physical systems where a product is manufactured. A cyber-physical system (CPS) denotes the combination of software-based computing components with mechanical and electronic parts, which intercommunicate via a data infrastructure, such as the internet. A cyber-physical system is characterized by its high degree of complexity. The development of cyber-physical systems is a result of the networking of embedded systems via wire-based or wireless communication networks. To this extent, a robot can thus be part of such a cyber-physical production system and itself have capabilities such as intuitive interfaces, recognition of behavior and skills of other machines and dynamic recognition of other robots.

With reference to the Vision of Industry 4.0, i.e. the linking of industrial production with information and communication technology, via which even small unit volumes can be realized, it is necessary to adapt the production process to the continuously changing requirements. Therefore, both humans and machines must have a multiplicity of skills. To this extent, the activity of humans and machines likewise no longer remains the same for extended periods of time, as it did in the past for production line work, but changes continuously with the products as these change in response to customer or market demand. This in turn places significant demands on the coordination and monitoring of the cooperation of humans and machines. The required number and type (human or machine) of members in a team and the skills of the individual members of the team will therefore have to change as often as the product changes.

Existing production systems do not yet support the assembly of teams of humans and robots by automated means.

### SUMMARY OF THE INVENTION

In view of the foregoing, it is therefore an object of the invention to provide a method via which teams of humans and robots can be assembled by automated means.

This and other objects and advantages are achieved in accordance with the invention by a method for assembling a team with the aid of a computer, where the team is assembled for the purpose of performing a specific task and where the team includes humans and robots as members. In accordance with the invention, the technical skills that are required to perform the task are specified, a subgroup of potential members having these technical skills are picked from a given group of humans and robots, and the members for the team are assembled from this subgroup via a genetic algorithm.

One way of performing the assembly of the team is provided by the Mean Absolute Percentage Error (MAPE) cycle in the context of Autonomic Computing. For the purposes of production within a company, Autonomic Computing comprises the computer-aided steps of self-configuration, self-optimization and self-healing. In the production process, in particular in cyber-physical production systems, the following uncertainties or errors can occur: limited predictability of human actions, unexpected behavior in the cooperation of humans and machines, unexpected or erroneous behavior of robots and/or components of the cyber-physical production system.

Therefore adaptable mechanisms must be provided in the planning and execution of the production, in particular the cyber-physical production system. This is achieved by the MAPE cycle, which represents a control loop. This means that various metrics (e.g., numerical values) of the production system are gathered in real time and are then used for the analysis and planning of the subsequent production process.

The MAPE cycle comprises the following steps 1 to 4, which are repeated continuously:

Step 1 is called “Metrics & Monitoring” and means here that the production system is monitored and those metrics of the individual parts of the production system are gathered, which are required for the assembly of the team of humans and robots.

Step 2 is called “Analysis & Optimization” and means here that, based on the metrics that have been gathered, an assembly algorithm is applied to assemble an optimal team of humans and robots with respect to the set task and the available technical skills.

Step 3 is called “Learning & Prediction” and means here that the behavior of the robots is calculated and the quality of the work of the robots is predicted by machine learning techniques, in particular “deep learning”. Deep learning signifies a class of optimization method that uses artificial neural networks that have numerous hidden layers between input layer and output layer and therefore have an extensive inner structure. The actual production is planned in step 4, which is called “Planning & Execution”. Step 1 can then be applied again in the actual production, and so on.

If the task of the team of humans and robots relates to the field of production, so-called resources are required for the production sequence in order to generate the product. The resources include both machines such as robots, CNC machines and 3D printers, and humans. Each resource has specific technical skills (subsequently also simply called skills) such as welding, drilling, assembling, and requires specific tools for this purpose. Humans and machines can have the same skills, though machines can generally employ the skills more quickly and precisely. The product is manufactured by the use of materials (e.g., bolts, or sheet metal). The definition of the product with regard to the materials to be used and the quantity thereof is specified in the Bill of Material (BOM), such as in the form of a database.

The production sequence controls the resources and coordinates the flow of material in the production system. The definition of the production sequence occurs in the Bill of Processes (BOP), for example. The sequence of the production steps, which also require specific skills, is specified there. The aim of the invention is therefore to find a team of humans and robots that can perform one or more specific production steps with respect to a production. The assumption in this case is that a production step, i.e., a task in the context of the invention, demands a plurality of skills that can be provided by humans and/or robots.

It would be simplest to pick the members of the team randomly from the available resources (humans, robots) having the desired skills. However, this would not generally produce an optimal result, firstly because both humans and robots improve their skills over time. The same resource can execute actions with different quality and speed. Secondly, there may be humans who are not used to cooperating with robots in relation to a specific skill or a specific product. Thirdly, humans become bored when they have to exercise the same action in an identical manner over an extended time period, even if they have significant experience of the action. Fourthly, the work of a robot for a specific skill can decline in quality due to mechanical wear of the robot over time. Fifthly, the preparation time required to equip the robot, e.g., with specific tools, may be lengthy and consequently render its deployment inefficient.

To this extent, the approach of the genetic algorithm is inventively chosen in order to assemble not only a team of any members having the required skills for the task to be performed, e.g., a production step in the production process, but also to ensure the effective and efficient cooperation thereof. When using a genetic algorithm, the starting point is nonetheless likewise a randomly assembled team of humans and robots each having the required skills.

A genetic algorithm usually consists of an initialization and a loop that is repeated until a termination criterion is satisfied. As part of the initialization, the first generation of solution candidates, i.e., a plurality of teams in this case, is usually built randomly. During the subsequent evaluation, a value for the fitness function is assigned to each solution candidate (i.e., to each team) of the generation according to its quality. Next, the following steps are performed until a termination criterion is satisfied: selection, specifically of individuals, here a team, for recombination; recombination, specifically combination of the selected individuals; mutation, i.e., random change of the descendants; and evaluation, in which each solution candidate of the generation is assigned a value for the fitness function according to its quality.

The fitness function is the target function, or part of a target function, of the genetic algorithm. Fitness functions have a biological model, the biological fitness, which specifies the degree of suitability of an organism to its environment. In the case of genetic algorithms, the fitness of a solution candidate describes how well the candidate solves the underlying optimization problem. A fitness function need not necessarily be able to calculate an absolute value, because it is often sufficient to compare candidates in order to select the better. A relative specification of the fitness would be, for example, team A is better than team B. If a solution is sought for a plurality of tasks concurrently (multi-target optimization) and it is not possible to combine said tasks, then the fitness function returns an ordered set rather than a single value.

In accordance with an embodiment of the invention, the fitness function includes a value for the technical skill proficiency. In this case, for the purpose of calculating the skill proficiency, provision can be made for using the number of skills successfully deployed (when tasks were performed previously) and the number of skills deployed (when tasks were performed previously).

Additionally or alternatively (to the value for the technical skill proficiency), provision can be made for the fitness function to include a value for the group cohesion. In particular, for the purpose of calculating the group cohesion, provision can be made for using how often the individual members of a group have already cooperated.

Additionally or alternatively (to the value for the technical skill proficiency and/or to the value for the group cohesion), provision can be made for the fitness function to include a value for the quality of the work that was previously performed by the team. In particular, for the purpose of calculating the quality of the work that was previously performed by the team, provision can be made for historical data to be used and subjected to a regression or classification.

For parallel deployment of a plurality of teams for a plurality of tasks, provision can be made for performing a bipartite assignment between teams and tasks. A bipartite assignment, e.g., in the form of a bipartite graph, is a mathematical model for relationships between the elements of two sets. Each team can therefore be assigned the task that it can best solve.

The inventive method can advantageously be used for tasks in industry. In particular, the method can be used for tasks in a cyber-physical production system.

Naturally, the inventive method can also be applied in other fields, e.g., the field of health, e.g., in the field of patient care, where a team of robot(s) and human(s) can lift or carry a patient requiring care.

Lastly, the present invention also relates to a computer program product comprising a computer-readable medium via which commands are provided in coded form, where after the computer program has been loaded the commands cause the computer to execute the steps of the inventive method. The invention is realized as a computer program (software). It can therefore be distributed as a computer program in the form of a file on a physical data medium or via a data network or communication network. Such computer program products and comparable computer program products or computer program elements are embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In order to further explain the invention, reference is made in the following part of the description to the figures, from which it is possible to derive further advantageous details and possible application areas of the invention and in which:

FIG. 1 shows a sequence diagram for a genetic algorithm in accordance with the invention;

FIG. 2 shows a learning curve in accordance with the invention;

FIG. 3 shows a link diagram in accordance with the invention; and

FIGS. 4-8 show bipartite graphs in accordance with the invention.

### DETAILED DESCRIPTION OF THE EXEMPLARY EMBODIMENTS

FIG. 1 shows a sequence diagram of a genetic algorithm such as can be used for the inventive assembly of the team of humans and robots that are to manufacture a specific product. It is a precondition in this case that the production sequence, with all of its production steps (actions) required for the manufacture of the product, is known and that the skills required for this purpose have been specified. This is ensured by the Bill of Processes (BOP). In addition, it must naturally be ensured that the required material for manufacturing the product is available. The material is specified by the Bill of Material (BOM). Therefore, when an order for a product is accepted, the order is often handled by an Enterprise Resource Planning system (ERP system). In this case, the required data is retrieved from the Bill of Processes (BOP) and the Bill of Material (BOM).

If the necessary preconditions for the production are satisfied, a plurality of resources should be available in order to be able to execute a specific production step with the required skill. If a welding step is to be performed, for example, a plurality robots having welding as a skill should be available. Or if parts are to be assembled, a plurality humans having the skill of assembly should be available.

In a first step 1, “Match resources with required skills”, before the actual genetic algorithm, the individual resources (i.e., humans and robots) are assigned their respective skill or skills, wherein this usually takes place automatically. Known algorithms, such as semantic models with semantic matching techniques, can be used for this purpose. A skill in this case can also be linked to conditions, such as restrictions, e.g., that a skill (or the associated action) must only be exercised by a robot.

In a second step 2, “Init mappings of skills, resources, weights”, based on step 1, a mapping is created of how well an individual resource satisfies a specific skill. This degree of satisfaction is expressed by a weighting. In addition to a specific skill, each resource is therefore assigned a weight that represents a measure of how well the resource masters this skill.

In a third step 3, “Initialize population of randomly composed teams”, a plurality of teams, i.e., in the context of the genetic algorithm, a population of teams are assembled on a random basis from the resources (humans, robots) having the relevant skills. A team consists of n members, where n can be predetermined. If each member has precisely one skill only, then n is determined by the number of skills required.

Only after this step 3 does the genetic algorithm start, comprising as step 4 in FIG. 1 all of the steps beginning with the number 4. If the maximum number of iterations has not yet been reached, this being checked at the decision point “Max iterations reached?”, then the “Create new population” occurs in step 4.1. In step 4.2, “Rank population by fitness”, the old population and its teams are ranked according to their fitness, usually in descending order. The fitness of a team is a measure of how well the team solves the set task, i.e., the associated optimization problem. The fitness is determined by applying a fitness function to the result of the team.

In step 4.3, “Copy small part of the fittest”, the fittest teams are selected, i.e., those with the best fitness. This is known as elitism. In step 4.4, “Add to population”, this subgroup of the fittest teams is added to the new population, and the new empty population is therefore filled with these teams.

In the step 4.5, “Build new population”, the new population is effectively processed: if the maximum size of the population has not yet been reached, in step 4.5.1, “Stochastically select from old population”, teams are randomly picked from the new population, which currently contains only the fittest teams of the old population. In step 4.5.2, “Crossover”, the teams that have been picked undergo a so-called crossover, which emulates a genetic reproduction. This means that members of a team are exchanged with members of another team, similar to an exchange of genes in the case of sexual reproduction. In step 4.5.3, “Mutation”, the members of a team are subjected to a mutation, meaning that one or more members are replaced by one or more randomly selected resources. The probability of a mutation is however set very low here, because this step would otherwise be tantamount to a random selection of members again. In step 4.5.4, “Add new offspring”, the processed team is then transferred into the new population. The steps 4.5.1 to 4.5.4 are performed for all teams selected in step 4.4 and newly generated teams.

Once the predetermined maximum population size, i.e., the maximum number of possible teams to be evaluated, is reached (“Max population size reached?”), all of the teams that were processed in step 4.5 are transferred into the new population in step 4.6 “Assign the new population”, and the new population replaces the old population. In step 4.7, “Evaluate population fitness”, the fitness of this new population is then determined. A fitness function is therefore applied to each team of the new population, and the fitness of each team is ascertained. Lastly in step 5, “Find best team”, the team with the greatest fitness is selected and output as a result: This is the team that would best solve the set task with the desired skills.

In the simplest case, the fitness function can result in a value. The heuristic creation of new populations can be terminated when either the total fitness converges or the maximum number of iterations is reached. For a specific team t, the fitness F is calculated as a weighted sum of metrics m, where w designates the individual weights:

F(t)=w1*m1+w2*m2+ . . . +wn*mn Eq. 1

The fitness lies in a value range from 0 to 1. The weights w can be allocated as desired, otherwise they are set to 1/n, where n corresponds to the number of metrics m used.

Use is preferably made of the following metrics: skill proficiency, group cohesion and quality of work.

The skill proficiency is used to measure the degree to which a resource is proficient with the specified skills. In production processes, the resulting quality of the product or the production step is measured, e.g., simply whether the product is satisfactory or not satisfactory. The skill proficiency is a measure of the development of a resource over time, and therefore does not depict the work (or its quality) as such, but its development over time.

Productivity and efficiency usually follow an experience curve. The general pattern is an initially rapid rise, followed by a slow tailing off due to reaching the practically achievable degree of improvement after a certain time. The experience curve can be modeled using mathematical functions, e.g., a sigmoid function, also referred to as a swan-neck function or S function (see FIG. 2). A measure of the time is plotted on the horizontal axis, either directly (as absolute time or as time spent on the production steps or actions) or indirectly as a number of actions or number of manufactured products. The experience E increases as time progresses. The vertical axis represents the learning or the learning success L. The learning success can increase, e.g., when the quality of the product increases, or decrease, e.g., because the time to perform the task increases.

A possible sigmoid function is:

L=1/(1+exp(x)), where Eq. 2

x=(s−NumSuc*Num)/f and s represents the minimum learning threshold, NumSuc represents the number of successfully deployed skills, Num represents the number of deployed skills, and f represents the factor for adjusting the rate of rise of the sigmoid function.

This method can be deployed to good effect for humans, and similar models can be used for machines and robots, e.g., a ratio of proficiency to experience. Proficiency in this case is the error rate or the accuracy of the machine during the learning, while the experience represents the number of practice products manufactured during the learning or the number of repetitions during the learning. In the case of teams of humans and robots, reciprocal learning can also be applied, where humans show the robots how to execute specific actions.

Group cohesion occurs when cohesive effects link the members of a group to each other or to the group as a whole. This can be illustrated as per the link diagram in FIG. 3. Nodes represent the individual members of the team, and the lines designate the links between the members as a result of previous cooperation. The numbers beside the lines indicate how often the members have already cooperated. Lines between humans and robots mean that the human has already cooperated with robots. Lines between humans mean that these humans have already cooperated in the past.

This illustration can be used as a basis for preparing a weighted matrix of the local community, Table 1 being taken as a starting point, where a-f designate the respective members of the team:

TABLE 1

| | A | B | c | D | e | f |
|---|---|---|---|---|---|---|
| a | | 7 | 9 | | | 14 |
| b | 7 | | 10 | 15 | | |
| c | 9 | 10 | | 11 | | 2 |
| d | | 15 | 11 | | 6 | |
| E | | | | 6 | | 9 |
| F | 14 | | 2 | | 9 | |

This can be used to calculate the values in Table 2:

TABLE 2

| | Sum of the weights of a | Normalized sum of a node | Degree of |
|---|---|---|---|
| | node | (average 0.92) | the node |
| A | 30 | 1.00 | 3 |
| B | 32 | 1.00 | 3 |
| c | 32 | 1.00 | 4 |
| d | 32 | 1.00 | 3 |
| e | 15 | 0.50 | 2 |
| f | 25 | 1.00 | 3 |

The normalization in column 2 is performed using the relationship:

normalization=1/(1+exp(s−Sum(Weights)), Eq. 3

where s represents the minimum learning threshold and Sum(Weights) represents the sums of the weights of the node.

In order to ascertain the group cohesion, each node is assigned a degree as per column 3 in Table 2, the degree corresponding to the number of lines to a node, the smallest degree being 2 in this case.

The measure gc of the group cohesion is calculated from the maximum possible cohesion, which is 1, minus the cumulative group value:

gc=1−(1−avg(normWgt)/min(Degree)), Eq. 4

where avg(normWgt) corresponds to the average normal weight per node, and min(Degree) corresponds to the smallest degree of a node. The example in Tables 1 and 2 gives:

gc=1−(1−0.92)/2=1−0.08/2=0.96

A value of zero for the value gc of the group cohesion is produced if there are no links between the nodes, i.e. the members of the team. A value of one is produced if total previous cooperation applies, i.e., avg(normWgt) is equal to one, and if the graph in FIG. 3 is completely cross-linked, i.e. the minimum number of links of a node is equal to the number of nodes minus one.

The quality of work (qow) for a specific team of humans and robots is predicted based on historical data. This can be realized via a machine learning model for classification and regression. The data set of historical data can be represented as per Table 3:

TABLE 3

| | | | | | | | | |
|---|---|---|---|---|---|---|---|---|
| a1 | a2 | a3 | . . . | b1 | b2 | . . . | Q | C |

| | | | | | | | |
|---|---|---|---|---|---|---|---|
| P1 | sp(a1) | | | | sp(b2) | Q_P1 | C_P1 |
| P2 | | | sp(a3) | | sp(b2) | Q_P2 | C_P2 |
| P3 | | sp(a2) | | | | Q_P3 | C_P3 |
| P4 | sp(a1) | | | | sp(b2) | Q_P4 | C_P4 |
| P5 | sp(a1) | | | sp(b1) | | Q_P5 | C_P5 |
| . . . | | | | | | | |

The rows relate to products P1, P2, P3, P4, P5, . . . , which were produced by a specific team. Each cell shows whether a specific resource was involved in the product with one of its skills. For example, if resource a applied its skill 1 to the product 1, sp(a1) designates the skill proficiency in this case. Each resource a, b has a plurality of skills 1, 2, 3, . . . . It is assumed here that each resource applies only one skill to a product.

The output value is either the quality Q of the product or its class C. Predicting the quality Q is a regression task and the output value is numeric. In order to predict the class C, a classification of the quality occurs and the output value is a category, e.g. “high” or “low”.

In order to obtain these predictions, it is possible to use neural networks, Support Vector Machines (SVM), Random Forest (RF) methods, or methods such as deep learning.

The fitness function for a team t can now be created as follows:

F(t)=wsp*avg(sp)+wgc*gc+wqow*qow Eq. 5

The first term contains the average proficiency avg(sp), the second term contains the measure of the group cohesion gc, and the third term contains the quality of work qow. The first term represents the development of the technical skills of the members of the team, the second term represents the cooperation experience of the team, and the third term represents the ability to build products with good quality.

In order to allow a plurality of teams to work in parallel for specific tasks, which would increase the throughput of the production line, it must be determined which task is to be assumed by which team of humans and robots in this case.

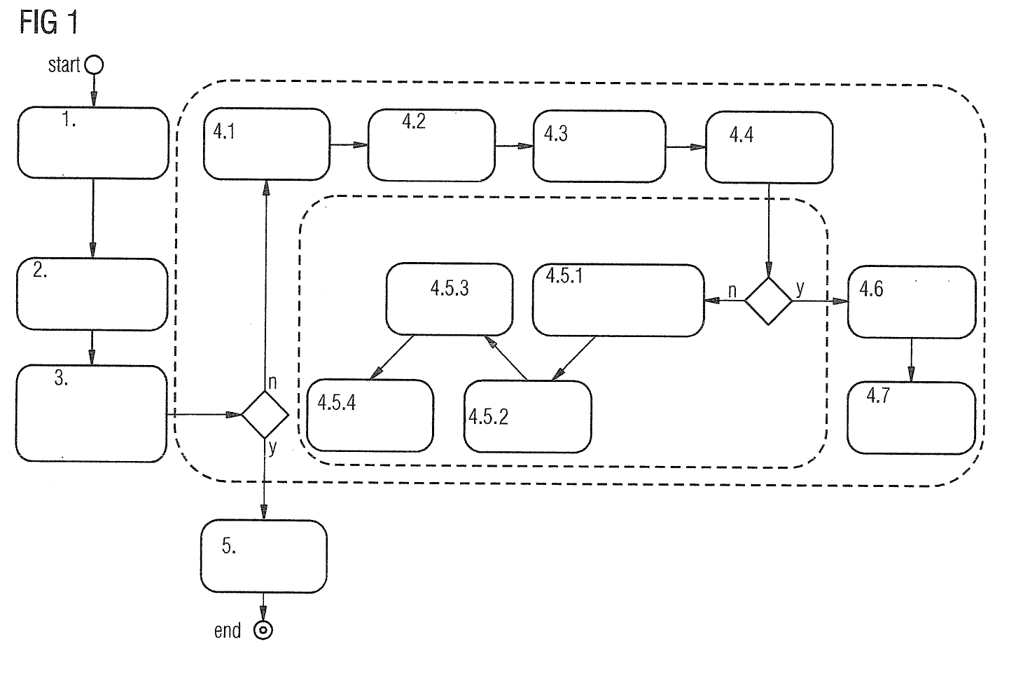

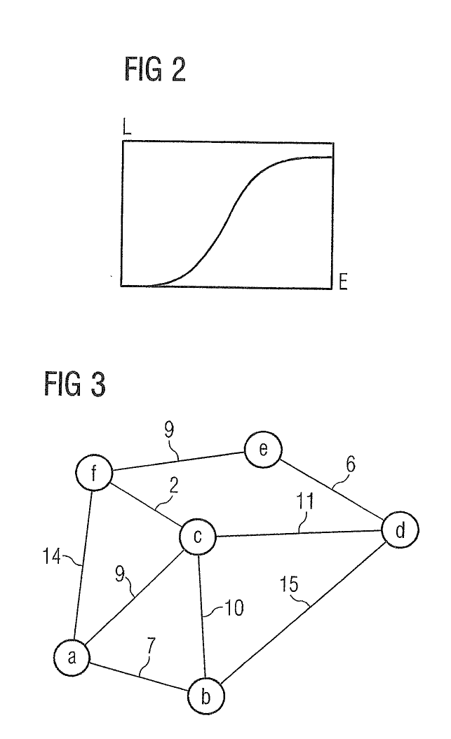

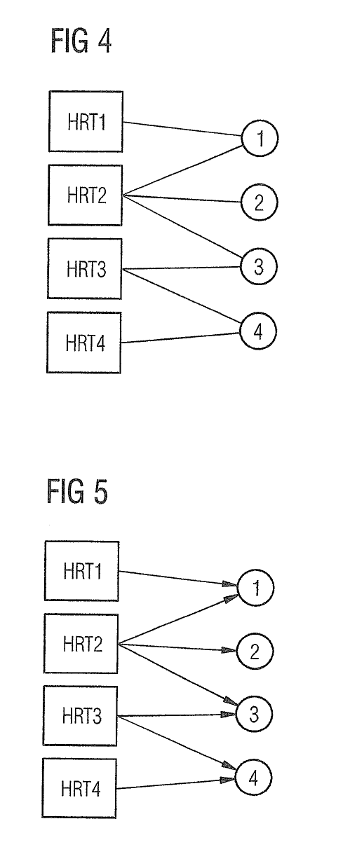

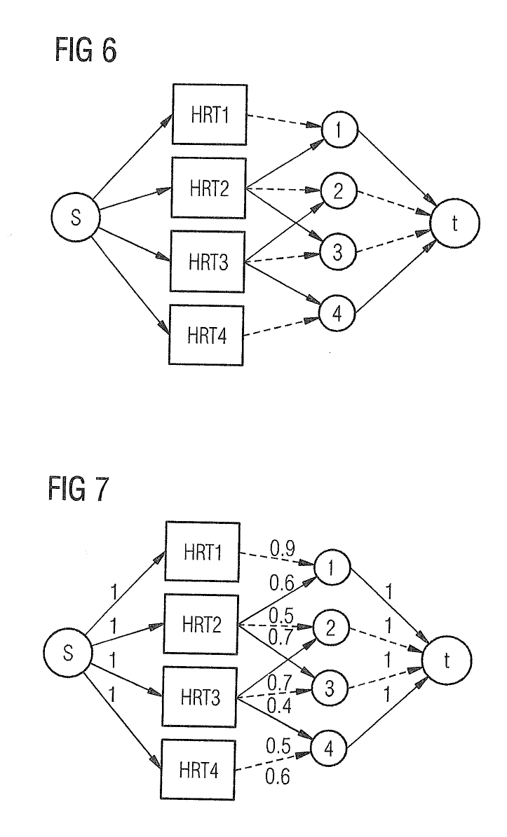

The problem to be solved here can be represented by bipartite graphs. A bipartite graph is a mathematical model for relationships between the elements of two sets. This is illustrated in FIGS. 4 to 8. A set of possible teams HRT1, HRT2, HRT3, HRT4 are represented on the left-hand side in FIG. 4 and a set of different tasks 1, 2, 3, 4 are shown on the right-hand side. Those teams that can perform specific tasks by virtue of their skills are linked to the tasks by an arrow (see FIG. 5). In FIG. 6, the problem is reduced to a network problem and the nodes s for source and t for target are inserted. In FIG. 7, weights are assigned to the individual links in the network. The weights are based on the values of the fitness of the individual teams. The values of the links starting at node s and leading to node 1 are set to one. The maximum flow is then calculated under the condition that, at most, one link can be selected which leaves an HRT node corresponding to a team HRT1, HRT2, HRT3, HRT4 in each case and that, at most, one link can be selected which leads to a task node corresponding to the tasks 1, 2, 3, 4.

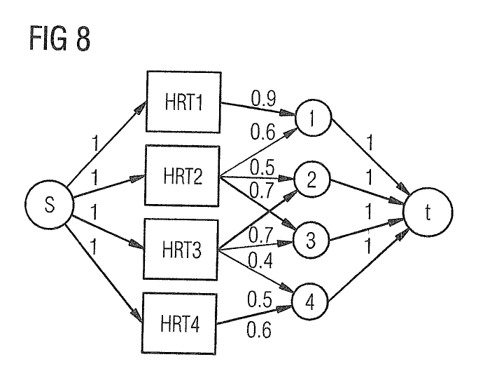

FIG. 8 illustrates the result of the assignment in the form of bold arrows. The result consists of pairs comprising a team and a task. Here, the team HTR1 is paired with task 1, the team 2 with task 3, the team 3 with task 2 and the team HT4 with task 4.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for assembling a team aided by a computer, the team being to perform a specific task and the team including humans and robots as members, the method comprising:
specifying technical skills that are required to perform the specific task;
picking a subgroup of potential members having these specified technical skills from a given group of humans and robots; and
assembling the members for the team from said picked subgroup via a genetic algorithm utilizing a fitness function.

2. The method as claimed in claim 1, wherein the fitness function includes a value for a technical skill proficiency.

3. The method as claimed in claim 2, wherein a number of skills successfully deployed and the number of skills deployed are utilized to calculate the technical skill proficiency.

4. The method as claimed in claim 1, wherein the fitness function includes a value for a group cohesion.

5. The method as claimed in claim 2, wherein the fitness function includes a value for a group cohesion.

6. The method as claimed in claim 3, wherein the fitness function includes a value for a group cohesion.

7. The method as claimed in claim 4, wherein how often individual members of a group have already cooperated is utilized to calculate the group cohesion.

8. The method as claimed in claim 1, wherein the fitness function includes a value for a quality of work that was previously performed by the team.

9. The method as claimed in claim 8, wherein historical data is utilized and subjected to a regression or classification to calculating the quality of the work that was previously performed by the team.

10. The method as claimed in claim 1, wherein a bipartite assignment between teams and tasks is performed for parallel deployment of a plurality of teams for a plurality of tasks.

11. The method as claimed in claim 1, wherein the method is utilized for tasks in industry.

12. The method as claimed in claim 1, wherein the method is utilized for tasks in a cyber-physical production system.

13. A non-transitory computer program product comprising a computer-readable medium encoded with commands provided in coded form which, when executed by a processor, cause a computer to assemble a team for performing a specific task, the team including humans and robots as members, the command comprising:
program code for specifying technical skills that are required to perform the specific task;
program code for picking a subgroup of potential members having these specified technical skills from a given group of humans and robots; and
program code for assembling the members for the team from said picked subgroup via a genetic algorithm utilizing a fitness function.
